(19) United States
(12) Patent Application Publication
(10) Pub. No.: US 2009/0301919 A1
(43) Pub. Date: Dec. 10, 2009

(54) PROJECT MANAGEMENT ORGANIZER CLIP

(76) Inventor: Steven Patrick Pascale, Costa Mesa, CA (US)

Correspondence Address: TROJAN LAW OFFICES, 9250 WILSHIRE BLVD, SUITE 325, BEVERLY HILLS, CA, 90212, US

(21) Appl. No.: 12/544,138

(22) Filed: Aug. 19, 2009

Related U.S. Application Data
(63) Continuation-in-part of application No. 11/178,217, filed on Jul. 8, 2005.
(60) Provisional application No. 60/690,294, filed on Jun. 14, 2005.

(51) Int. Cl. B65D 85/00; B42D 17/00

(52) U.S. Cl. 206/459.1; 281/44; 281/45; 206/459.5

(57) ABSTRACT

An ergonomic organizer device having enhanced organizational functionality comprising a clip integrally formed on the card which is configured to retain paper, the clip formed by a tongue disposed in a cut shape opening, and at least one indicator such as a flag or category wheel that is movably mounted on a surface of the card, wherein the indicator is coded for a designated purpose to facilitate organization and coordination.

### STATEMENT OF PRIORITY

This application is a continuation-in-part of U.S. patent application Ser. No. 11/178,217, filed on Jul. 8, 2005, which is hereby incorporated by reference in its entirety.

### BACKGROUND OF THE INVENTION

1. Field of the Invention

The invention relates generally to the field of office supplies, more specifically, the invention relates to devices to organize pertinent information.

2. Description of the Related Art

In the modern team oriented workplace, collaboration, coordination and communication among members of a team are essential for effective delivery of quality products and services. But previous attempts at creating a clip based organizer to provide some of the required functionality have fallen short of delivering the collaboration, coordination, and communication functionality necessary to enhance delivery of products and services.

Across almost all industries, productive collaboration among members of a team is essential to ensure quality products or services are delivered to a customer's satisfaction. For example, collaborative efforts are required for activities such as product development, promotions, finances and budget, HR, scheduling and various services. To effectively oversee a collaborative team effort, managers alike must be concerned about a number of variables, and collaboration among team members is necessary to achieve a most effective utilization of resources.

Similarly, to ensure quality products and services are delivered, a manager is charged with coordinating team members and work tasks. Such coordination is typically directed towards ensuring that activities are carried out in relation to their importance and with minimum of conflict.

Communications in the workplace among team members or workers and supervisors is vital to the success of any project. Effective communications minimize ambiguity and perception differences. Alternatively, miscommunications can lead to poor decisions and poor quality products.

When handling documents in a work environment, paper clips, binder clips, tape flags, and self-adhesive notes have been used to facilitate communications among team members. However, these devices are quite limited in their ability to facilitate coordination, communications, and collaboration among team members as they provide, at best, small writing surfaces and typically have no mechanism for leaving a lasting record to later team members. Moreover, such organizer devices are often limited to marking the placement, position, or location of a file, without the ability to communicate status or action required.

### SUMMARY OF THE INVENTION

In light of the shortcomings of the noted above, there is a need for an organizational device that is capable of gripping and retaining one or more planar elements, such as sheets of paper and that provides enhanced organizational functionality that can easily be carried or put into a shirt pocket. Additionally, there is a need for a clip-based organizational device that facilitates collaboration, coordination, and communication among members of team.

In contrast to the limited organizational functionality of the prior art, one aspect of embodiments of the present invention is to provide organizational devices which are capable of gripping and retaining one or more sheets of paper, and provide enhanced organizational functionality to facilitate collaboration, coordination, and communication among team members. These organizational devices clip to the sides of a sheet or sheets of paper, folders, documents or reports. These organizational devices have broad applicability and can be used across many industries. For example, they can be used for quality control tagging functions within the manufacturing process, retail promotions, software licensing, movie making dailies, or air traffic control pilot clearances, restaurant services, or medical and dental care. The advantages realized by the various embodiments of the present invention provide time-saving value by any definition.

Another aspect of the organizer devices is that they assist people in overcoming the limited functionality that exists with regards to conventional organizers and self-adhesive notes. A purpose of the organizer devices of the present invention is to provide an organizer device having enhanced features such as reusable writing surfaces, indicia marking surfaces, and enhanced gripping capabilities. An example of this might be adopted for industry wide use in the healthcare arena. In an industry that cries out for simplification, reduction of malpractice risk, and extremely detailed coding efforts, the apparatus offers simple solutions without the large capital dollar outlays many companies are trying to offer. For example: Polypharmacy—Physicians today, particularly primary care physicians are under a tremendous amount of pressure. In order to generate a sound bottom line for their practice, they must see more patients per day than any other time in history. In addition to speeding patients through the office, they are also under constant watch by insurers, health plans, and regulators to see that they do as much as they can in their own offices before referring patients out to specialists; or for costly diagnostic procedures. There is risk involved in ‘speed’ and seeing larger volumes of patients. Doctors cannot possibly ‘recall’ a patient's individual treatment protocol based on ‘seeing’ that patient. Time limitation makes it inefficient for the doctor to flip through a chart that often times is well over an inch thick.

A phenomenal adoption of this invention would address the doctor's time, speed, efficiency, and most importantly the accuracy needed to treat properly. Example: Mrs. Smith sees Dr. Jones. She has not been to the office for 6 months. Mrs. Smith is 70 years old and has been to Dr. Jones, for her arthritis, her diabetes, her high blood pressure, and several bouts of depression. Recent lab work now shows Mrs. Smith will most likely need to begin treatment with Lipitor. Dr. Jones would have to carefully review her chart to see what other medications she is on. The chart is two sided and includes at least an inch of notes and test results that Dr. would have to flip through. If he were to utilize the organizer device, and identify as procedure, a place in the chart for the card to be attached, a notation could be made at ANY visit, when Mrs. Smith is prescribed a medication and the date for that prescription. A color code can be utilized to indicate the drug treatment will be ongoing as the condition is chronic (i.e. diabetes, high cholesterol), but she may have been given an antibiotic for bronchitis, which is a one time event. Allergies can be identified on the Clip as well. Dr. Jones can look immediately to each patient's “card” for the quickest snapshot of what pharmacy regimen Mrs. Smith is living with. He saves the time of going through the chart. Mrs. Smith is pleased that Dr. Jones quickly recalls her protocol. Dr. Jones can quickly review for drug interactions, required dosage changes, or even unnecessary meds the patient might no longer need with further inquiry. Risk managers would view this as extremely beneficial when evaluating Dr. Jones' malpractice coverage. Danger of mix up is minimal as the Organizer Clip will have the patient's name and if the chart is ‘missing’ an Organizer Card-Clip then Dr. Jones knows to look more carefully at the full chart.

The said invention can also serve as an extremely efficient tool for nurses reviewing patient charts for insurance bill codes. In today's insurance world, reimbursement for patient services has become cumbersome and difficult for providers. In order to receive maximum reimbursement, the physician must remember not just what the patient comes in to be seen for, but also all of his or her other co-morbidities!! Let's go back to Mrs. Smith and Dr. Jones. Mrs. Smith is a Medicare patient. Dr. Jones sees Mrs. Smith for depression. He talks with her at length and determines that she does not need a psychiatric referral, but would like to test her on an anti depressant medication. Current Medicare payment methodology will pay Dr. Jones $24.00 if he bills for treatment of depression only. If he bills that he is treating a diabetic for depression, they will reimburse $30.00. If he bills that Mrs. Smith is a diabetic, with high cholesterol, and common arthritic flare-ups, and in this visit for depression, reimbursement jumps to $52.00. Although these rates are hypothetical, this is exactly how the methodology works. The doctor's office staff is not likely to catch all of these comorbidities by simply reviewing the doctor's notes for that visit. Now add an “Organizer Clip” to the billing section of the chart that clearly and briefly states all of Mrs. Smith's diagnoses. The nurse is quickly and simply able to ‘code’ the billing correctly so that Dr. Jones' reimbursement is now both correct as well as maximized. The Upshot: Time is saved, accuracy is improved.

Embodiments include a clip-based organizer device capable of attaching to single and/or multiple layers of paper, card stock type materials, and other working elements that can be clipped or flagged. A clip based organizer of the present invention may effectively be used to optimize A) administrative and strategic functions (examples: quality/customer satisfaction); B) team work and systemized concurrence; and C) exchange of information, messages, or directives informatively.

In certain embodiments, an organizer device is capable of gripping and retaining one or more sheets of paper and provides enhanced functionality to facilitate collaboration, coordination, and communication among team members. The organizer device comprises a card having a quasi-rectangular ergonomic shape formed from a firm card stock, hybrid plastics or polymer, a clip formed on the card and configured to retain at least one sheet of paper, a notepad removably affixed to a surface of the card, a first indicator movably mounted to a surface of the card. The indicator can be comprised of flags or category wheels as described below. The card has a substantially linear perforation allowing one section of the card to be removable from a remaining section of the card. The clip includes a lower clip portion, an upper clip portion, a tongue portion, a plurality of perforated sections disposed on a central area of the tongue portion, and a rubber shim having a plurality of raised bumps disposed on a lower edge of the tongue portion, and a window where an instruction is denoted on the back of the indicator wheel like proceed, confer or cease. Another perforation may be included located on one of the upper corners for a ring or Chicago screw in order to attach multiple embodiments of the same invention so that one can “fan” multiple cards. The primary notepad comprises a plurality of sheets of paper, and the secondary notepad comprising a plurality of sheets of paper.

In certain other embodiments, an organizer device comprises a card having a front surface and a back surface and a clip formed on the card and configured to retain at least one sheet of paper. The card may be comprised of card stock weight paper or plastic that has been cut to a desired shape. The card may be laminated on at least one surface for additional durability and to provide a reusable writing surface. The card has a multitude of areas where distinguishable indicia may be disposed. The further comprises a lower clip portion, an upper clip portion, a tongue section, and at least one gripping surface disposed on the tongue section. The clip is configured to attach and or multiple layers of paper, card paper stock type materials and other working elements that can be clipped or tagged. Given the versatility of the clip, the organizational device can be placed in various designated locations (top, bottom, left, or right edges of documents/reports) highlighting important areas of the attached sheet or sheets. The gripping surface of the clip may be comprised of a natural rubber or synthetic rubber shim cut ranging from 1 degree to 30 degree on the upper portions. To enhance friction between the gripping surface and an attached document, the gripping surface may be reduced in its material thickness (say 1/32 to 1/16). To further enhance stability on a gripped document, the card may feature a pressure adhesive strip on the back surface of the card.

In certain other embodiments, an organizer device comprises a card having a front surface and a back surface and a clip disposed on the card and configured to retain at least one sheet of paper. The card comprises an upper portion such that the lower portion, and a perforation between the upper portion and the lower portion such that the lower portion is separably attached to the upper portion. The lower portion may additionally feature removable punch out sections to facilitate filing-card-like indexing or detachable receipt functionality for the removable lower portion of the card.

In yet other embodiments, an organizer device comprises a card having a front surface and a back surface, a clip disposed on the card and configured to retain at least one sheet of paper, a primary notepad removably adhered to the front surface of the card, and a secondary notepad removably adhered to the front or back surface of the card, or a static cling-crack n'peel advertising label. The primary and secondary notepads may have pressure sensitive adhesive areas and/or clipping capability. The pads themselves are for writing notes. Furthermore, these notes can be strategically removed and placed on secondary documents where warranted. The two notepads can be replaced as desired. Additionally, writing surfaces are provided by the front and back surfaces of the card, which may be laminated, made of plastic, acrylic coated panel with conductive layer in order to facilitate a rewritable surface if washable ink markers, ball point/roller-ball pens, or even a stylus are used.

In other embodiments, methods of making an organizer device having a card and a clip formed on the card are disclosed. The methods include providing paper for at least one card, cutting the card with a laser or steel rule die to form a clip having a tongue and a cut window, and cutting the card from the paper or plastic. Laser die marked rule cutting allows the clip to be cut with precise tolerances, thereby facilitating the production of a clip which may be used to retain a standard-sized (2″ width) business card and standard-sized credit card (2.25″ width) or other documents of known dimensions.

In still other embodiments, methods of using an organizer device are disclosed. The organizer device includes a card having a quasi-rectangular ergonomic shape formed from a firm card stock or plastic—polymer and a clip formed on the card and configured to retain at least one sheet of paper, the clip comprising a lower clip portion. The card may have a substantially linear perforation, allowing one section of the card to be removable from a remaining section of the card. The clip includes an upper clip portion, a tongue portion, a plurality of perforated sections disposed on a central area of the tongue portion, and a gripping surface disposed on the lower edge of the tongue portion. The methods of using the organizer device include inserting at least one sheet of paper into the clip such that the gripping surface of the clip retains the sheet of paper; and marking status information about the at least one sheet of paper on the card.

Embodiments of the organizer device advantageously serve as organizers with enhanced administrative functions such as an information transport, 3×5 file card, business card/credit card holder, project status display, and note or memo writing surface. Thus, the organizer device apparatus may provide the ability to write notes, place value or importance levels regarding those notes or the retained documents and confer an added level of utility to project document organization and/or administration.

According to various embodiments, the organizer device may be constructed to various desired shapes and sizes corresponding to various intended uses. The organizer device may provide various features to enhance the coordination, communication, and collaboration supported by the device. For example, project headers specifying specific types of functional areas may be present on the card of the organizational device. Moreover, the organizer device may also comprise boxes indicating level of importance (for example on a 1-5 scale) and the percentage complete (0%-25%-50%-75%-100%) on a project to signal a particular decision has been made to future users of a document. Other features to enhance coordination, communication, and collaboration by the organizer device include an indicator, comprising movable flags or rotatable category wheels, which is color coded for a designated purpose.

The rotatable flags wheel are color coded for a designated purpose (e.g. classification, arrangement, taxonomy) to facilitate organization and coordination. In an embodiment of the invention, the organizer device has at least one rotatable flag. The rotatable flag can take the form of a rectangular flag, a trianugular pennant flag, or any shape so long as it operates for its intended purpose. The flag can have a single color or a plurality of colors. Each color is coded for a designated purpose, such as to indicate the status of the matter to which the organizer device is applied, including its importance, its percentage of completion, or the time for its completion. For example, a single colored flag can be used as a “reminder” or to indicate that attention is needed “now”. A multi-colored flag comprising colors green, yellow, and red can be coded to indicate that green represents “active file”, yellow represents “suspended file” or red represents “closed file”. Any number of colors or color combinations can be used as indicia.

The flag can be mounted to an upper portion of the card, the upper portion defined by a top edge, such that the flag can be rotated from a position below the top edge to a position above the top edge to enhance visibility of the flag. The flag can also be located at different positions on the upper portion of the organizer device, including at the corners of the upper portion or at the center of the tongue portion of the clip. The flag can be located on the front side or the back side of the organizer device.

In certain embodiments, the organizer device has a rotatable wheel containing a plurality of colors. The wheel can be rotated to move each color into a designated position, preferably above the top edge of the card, to communicate an instruction. Each color is coded to represent a category or other signifier to enhance coordination, communication, and collaboration.

In an embodiment of the invention, a plurality of flags or wheels can be used to designate a multiplicity of different purposes. For example, an embodiment of the invention may contain a first flag on the front side and a second flag on the back side of the organizer device, or a flag at the corner of the upper portion and a wheel on the tongue portion of the flip, each indicator having different colors for different code assignment. Where the organizer device is used in the restaurant service industry, for example, a card having a plurality of flags or wheels can be used to coordinate customer service. For instance, a first flag can be color coded to designate the status of the food delivery (e.g. green representing “attention required” or “order to be taken”; yellow representing “order ready to be taken” or “food ready for delivery; and red representing “do not disturb” or “food delivered”) and a second flag can be color coded to designate the status of the customer bill (e.g. blue representing “paid bill” or orange representing “unpaid bill”).

In another embodiment of the invention, the plurality of flags or wheels can be centrally connected at a common point on the organizer device. An organizer device according to this embodiment will have a plurality of flags that rotate about a common axis. For example, three integrally connected flags, each flag representing a designated category, can be mounted to a common eyelet or grommet or other fastener such as to enable the flags to rotate together. In this embodiment, each flag is coded for a different purpose, such as to “proceed”, “cease”, or “confer”.

The flags of the organizer device can also have printed indicia, such as the words “ready” or “later” to signify the required attention, or the words “proceed” or “cease” to signify status.

In certain embodiments of the invention, the organizer clip has a light emitting diode (LED) connected to a power source. The LED can be used as a light source for writing on the organizer clip or to give a designated signal. For example, where the organizer clip is used in the restaurant service industry the LED can be used to signal that a table is “ready” or to track location of restaurant patrons.

The organizer clip can have plurality of LEDs. In an embodiment of the invention, the organizer clip has three LEDs connected to a category wheel, such that rotation of the category wheel controls actuation of the LEDs to enhance organization and coordination.

In certain embodiments of the invention, the organizer clip has a slot or cutout in the upper portion for attaching an accessory, such as a paper clip, pen, or other instrument.

In certain embodiments of the invention, the organizer clip has a hole for attaching a lanyard so that the card can be easily accessible and can be used also as a name badge.

For purposes of summarizing the invention and the advantages achieved over the prior art, certain aspects and advantages of the invention have been described above and as further described below. Of course, it is to be understood that not necessarily all such aspects or advantages may be achieved in accordance with any particular embodiment of the invention. Thus, for example, those skilled in the art will recognize that certain embodiments may achieve or optimize one advantage or group of advantages as taught herein without necessarily achieving other aspects or advantages as may be taught or suggested herein.

All of there embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a front view of an organizer device according to an embodiment of the present invention.

FIG. 2 is a rear view of the organizer device of FIG. 1.

FIG. 3 is an expanded rear view of a primary notepad according to certain embodiments of the present invention.

FIG. 4 is an expanded rear view of a secondary notepad according to certain embodiments of the present invention.

FIG. 5 is a perspective view depicting a preferred embodiment of the organizer device as applied to an article.

FIG. 6 is a perspective view depicting a preferred embodiment of the organizer device as applied to an article.

FIG. 7A is a front view of an organizer device according to an embodiment of the present invention having a category wheel.

FIG. 7B is a rear view of an organizer device according to an embodiment of the present invention without the category wheel.

FIG. 7C is a rear view of a category wheel.

FIG. 7D is a rear view of a flag.

FIG. 8 is a front view of an organizer device according to an embodiment of the present invention having a light emitting diode.

### DETAILED DESCRIPTION OF THE PREFERRED EMBODIMENT

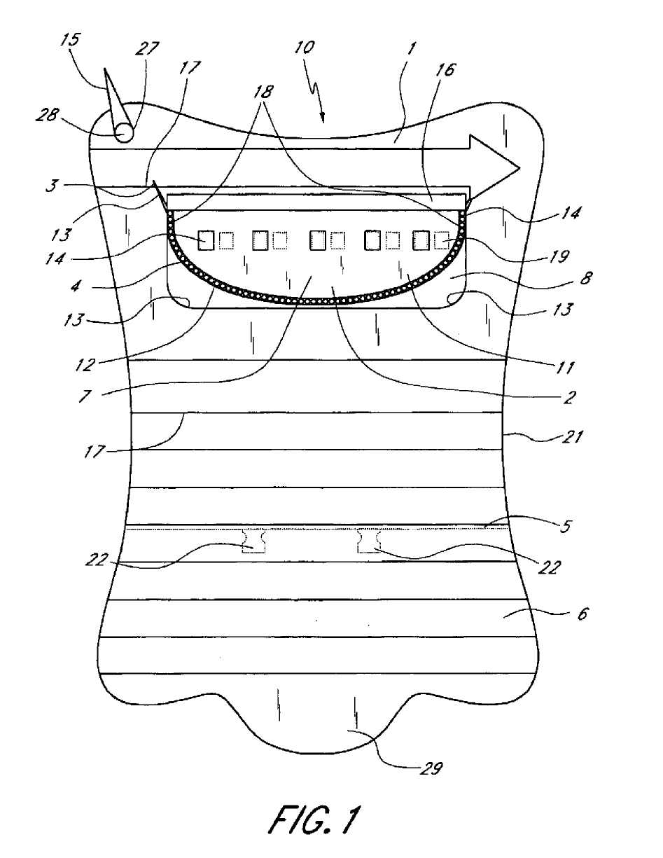

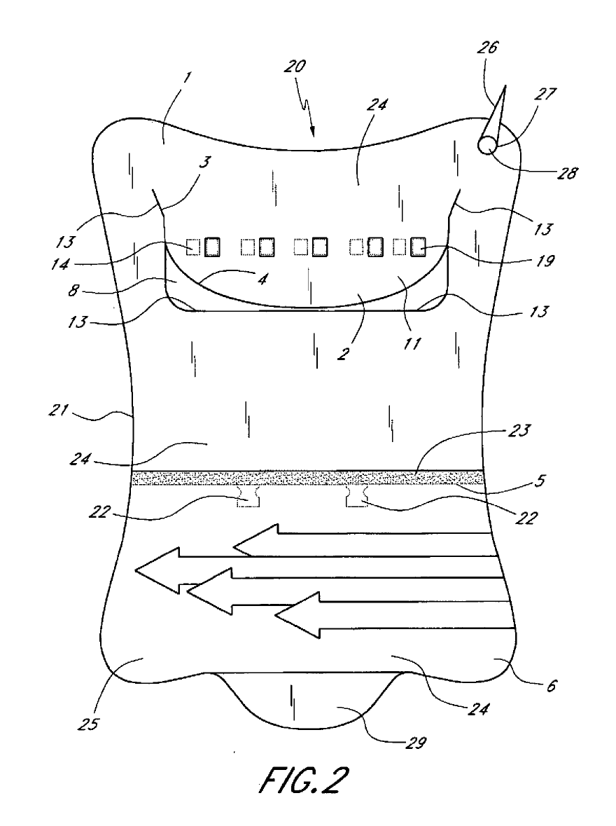

Specifically, with respect to FIGS. 1 and 2, an organizer device of the present invention is depicted. FIG. 1 depicts a front view of an embodiment of the organizer device, and FIG. 2 depicts a rear view of the organizer device of FIG. 1. As depicted in FIG. 1, the organizer device comprises: a card 1 having a front surface 10 and a clip 2 comprising a tongue portion 11 and a gripping surface 12. The user environment may define how the organizer device helps organize various project functions in a way that makes sense for a user of the organizer device. Thus, the integration of various combinations of different features, as described in greater detail below, in an organizer device will form various embodiments of an organizer device according to the present invention.

The Card of the Organizer Device

The card 1 may be comprised of a firm card stock, plastic, or other pliable material. Preferably, the card 1 is comprised of card stock or plastic having a weight ranging from 0.01 to 12 oz. The card 1 may be laminated on at least one surface for additional durability and to provide a reusable writing surface. For example, either or both of the front surface 10 and the back surface 20 (FIG. 2) of the card 1 may be laminated if made of card stock to provide a reusable writing surface when written on with washable ink markers or erasable ball point/roller ball via isopropyl/ethyl alcohol type based cleaners. Preferably, the laminate is between approximately 1.0 mil thickness thin gauge and 20 mil thick, although other custom thicknesses are contemplated and are within the scope of the present invention.

In one preferred embodiment, the card 1 of the organizer device is perforated horizontally at approximately its mid-section to upper section, allowing a lower portion 6 of the card 1 to be removed from a top portion. There is a perforation 5 disposed horizontally across the card 1 of the organizer device that allows the lower portion 6 to be removed. In certain embodiments, the lower portion 6 also includes at least one knock-out tab 22 that allows the removable lower portion 6 of the organizer device to be inserted into a card indexing file. Advantageously, this card indexing feature may facilitate communication and collaboration of group members as subsequent users of a document can rapidly located indexed information pertaining to a document.

In certain embodiments, and as depicted in FIGS. 1 and 2, the card 1 of the organizer device is a quasi-rectangular ergonomic shape. The shape features concave edges 21 (for human factors) along its four outer sides, giving it a lobed appearance. A fifth lobe 29 may be disposed at the center of the bottom side, and may be used as a handle for raising, lowering or removing the organizer device. The fifth lobe 29 may also contain a hole for attaching a lanyard so that the organizer device can be conveniently carried or used as a name badge. Additionally, a fifth lobe can be used as an anchor while sitting in a female receiver device. This lobe shape creates an organizer device that is both aesthetically pleasing and ergonomic. While the particular lobed shape illustrated is believed to have certain ergonomic benefits, other shapes may be used which possess similar ergonomic benefits.

The organizer device card 1, along with the clip 2 and perforations 5, 22 are preferably cut via a laser or steel rule die-cut and or other similar means in order to produce clean, sharp and durable edges. In another embodiment, the organizer device has an overall card tear-out perforation cut, allowing the organizer device to be vended in sheets that may be fed through a home or office printer; thus, allowing the ability to personalize the contents or theme of the organizer device, or to produce organizer device cards 1 in a series where necessary. Advantageously, this printable configuration allows the organizer device of the present invention to be adaptable to a wide variety of uses such that the collaborative benefits offered by various embodiments of the organizer device may have wide applicability.

The fifth lobe 29 provides a front side (shown in FIG. 1) and a back side (FIG. 2) for disposing marking indicia. For example, the front side or the back side of the fifth lobe 29 may be marked with (adhesive peel-off) stickers or printed letters (raised by melting plastic particles through a process known in the art as ther-m-ography). The marking indicia can be used to identify one indexed lower portion 6 of an organizer device card 1 out of a group by observing the marking indicia such as color or alphanumeric designations on the lobe. The curvature of the fifth lobe 29 design may permit the labeling section of the organizer device to sit above a page allowing an intended recipient user to grasp the organizer device from the top when clipped to papers.

Although uniform in shape, the organizer device card 1 may come in a range of sizes, from preferably approximately 1.9 inches by 2.3 inches to approximately 3.0 inches by 5.25 inches. Desirably, the organizer device card 1 has a dimension ranging from approximately 1.5 inches to 11 inches. Although these sizes are demonstrative examples, other sizes may be included as necessary depending on the field of application of the organizer device.

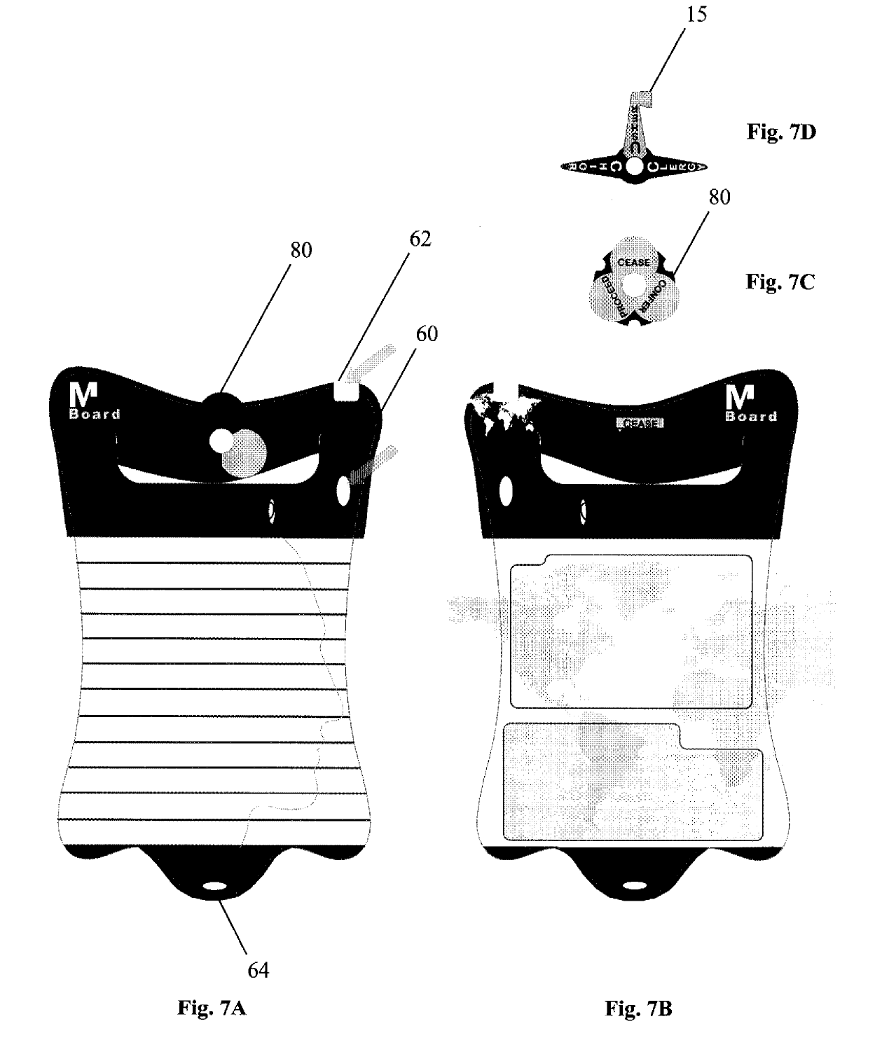

In certain embodiments of the invention, the organizer device card 1 has slot 60 or cutout 62 as shown in FIG. 7 in the upper portion for attaching a paperclip, pen or other instrument.

In certain embodiments of the invention, the organizer clip has a hole 64 for attaching a lanyard so that the card can function also as a name badge.

According to a preferred embodiment of the invention, the organizer device having enhanced organizational functionality comprises a card 1 having an ergonomic shape, a clip 2 integrally formed on the card 1 and configured to retain at least one planar element, such as a paper, the clip formed by a tongue 11 disposed in a cut shape opening 13, and at least one flag 15 or category wheel 80 as shown in FIG. 7 is coded for a designed purpose to facilitate organization and coordination.

The Flags of the Organizer Device

In one preferred embodiment, a small generally triangular flag 15 is disposed on an upper corner or center of the tongue of the card 1 of the organizer device through the utilization of a grommet or an eyelet 28 or other fastener. The eyelet 28 or other fastener may be inserted into a cut aperture 27 in the card1, such as a die cut aperture. The flag 15 is rotatable in the plane of the organizer device card 1 as an additional communication vehicle for denoting project progress and/or attention needed. For example, the flag 15 may be used to indicate whether or not to proceed with a particular task—a so called go-no go decision. In certain embodiments, the flag 15 may be color coded. For example, the flag 15 may be green to indicate a decision to proceed has been made on an attached memo or other document. In certain embodiments, the flag 15 may be laminated or made of plastic. Advantageously, the flag 15 allows one viewer of an article to communicate with subsequent users of a document such as to indicate that a particular article is of interest or that a decision has been reached regarding a particular article.

In another preferred embodiment of the invention, the card 1 of the organizer device includes a plurality of flags 15. The plurality of flags 15 are mounted to a common eyelet 28 or other fastener, such as to rotate about the axis of the eyelet 28. As shown in FIG. 7-D, three pennant flags are integrally connected, wherein each flag represents a designated purpose. In this embodiment, each flag is color-coded for a different purpose or have printed indicia.

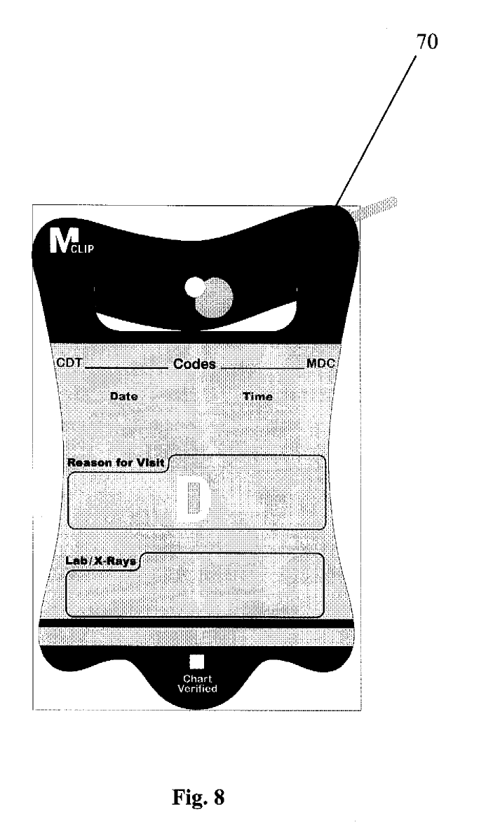

Referring to FIG. 8, in certain embodiments of the invention the organizer clip has a light emitting diode (LED) 70 that can be used as a light source for writing on the organizer clip or to give a designated signal. A plurality of LEDs 70 can be connected to the flags 15, such that rotation of the flags 15 controls actuation of the LEDs 70 to enhance organization and coordination.

The Category Wheels of the Organizer Device

In certain embodiments of the invention as shown in FIG. 7A, the organizer clip has a category wheel 80 of a circular or semi-circular shape that is attached to the card by a eyelet 28 or other fastener. The category wheel 80 rotates about the axis of the eyelet 28. An LED 70 can be connected to the category wheel 80. The category wheel 80 can be color-coded or have printed indicia to enhance coordination, communication, and collaboration.

The Clip of the Organizer Device

The clip 2 may retain an edge of a sheet or sheets of paper, a folder, report, document, manual or other similar surface. A sheet or sheets of paper, a folder, report, document, manual or other similar surface are collectively referred to herein as an article. As depicted, the clip 2 is formed on the card 1 by a cut shape 13 of the clip 2 defining an upper clip portion 3, a lower clip portion 4, and a tongue section 11. The cut shape 13 may be formed by die cutting. Preferably, the cut shape 13 is formed by laser or steel rule die cutting. Advantageously, laser outlined and/or steel rule die cutting allows precise tolerances to be met such that the clip 2 may be configured to retain specific document sizes. In certain embodiments, a cut shape 13 formed as a die cut window is horizontally centered in the top half of the organizer device card 1. The cut shape 13 has two sides and a bottom consisting of generally straight cuts with rounded edges connecting them. The tongue section 11 extends towards the bottom of the cut shape 13. As depicted, there is an aperture 8 of removed card material between an edge of the tongue section 11 and the cut shape 13. As discussed in further detail below, the sides of the cut shape 13 are configured to create an upper clip portion 3 and a lower clip portion 4 such that the cut shape 13 is configured to grip an edge of an attached article (at the junction of the tongue section 11 and the upper ends of the cut shape 13). The upper and lower clip portions 3, 4 and the configuration of the cut shape 13, with two side cuts extending slightly upward and outward near their upper ends serves to increase the gripping strength of the tongue section 11 and clip 2 when the organizer device grips an article. Advantageously, the higher the gripping ability of the organizer device enhances collaboration and communication among team members as, unlike self-adhesive notes, the organizer device is not likely to become separated from their attached articles.

In certain embodiments, the overall width of the cut shape 13 (clips mid section) is approximately 1.988 inches wide to create a tension fit with standard size business cards, which have a width of 2 inches in portrait orientation (2 inch height if in landscape orientation). In other embodiments, the overall width of the cut shape 13 (clips upper section) is approximately 2.238 inches wide to create a tension fit with standardized size credit card, which have a width of 2.25 inches in portrait orientation (2.25 inch height if in landscape orientation). In this manner, the cut shape 13 of the clip 2 also serves as a business card/credit card holder 18, allowing one or more business cards and a single credit card to be retained in the clip simultaneously 2 of the organizer device while it adheres to an article. This business card 1 credit card retaining feature allows the organizer device to enhance communications among team members as contact information such as that for a user with primary responsibility for an article can be retained with the article.

The lower clip portion 4 has a downward facing mouth opening to an inner surface, which is shaped to accept an article such as a document, report, folders or board like instrument (including manuals) front vertical edge by applying the clip downward onto the article thereby pushing a mouth of the clip 2 apart to accept the article. The upper clip portion 3 has an upward facing mouth opening to an inner surface, which is shaped to accept separate cylindrical articles of differing diameter.

When applying the organizer device to an article, first, the lower clip portion 4 is placed on the article by pushing the article into the clip 2 thereby urging the tongue section 11 apart from the card 1 such that the clip 2 accepts and holds the article in place. Then, the article is advanced further into the clip 2 such that the upper clip portion 3 of the organizer device is pushed apart to accept and hold the article in place.

The gripping surface 12 may be comprised of a material such as a natural or synthetic rubber that provides enhanced gripping ability. Preferably, the gripping surface 12 comprises a shim disposed on an upper edge of the tongue section 11 to serve as a tacky surface to enhance grip on a gripped article. The gripping surface 12 may also comprise a horizontal shim 16 extending generally horizontally across the upper edge of the tongue section 11. The gripping surface 12 may feature a variegated surface, with small raised areas for instance, to help the gripping surface 12 increases the tensile strength of the upper tongue section 11 when in contact with papers or documents held by the clip 2. Additionally, when variegated, the gripping surface 12 provides an improved finger gripping texture for the organizer device.

In certain embodiments, a front side of the tongue section 11 contains perforated sections 14 to indicate the degree of completion of a task, or other indicia that can be indicated with a small mark and/or by punching out a section along the perforations. Although they are depicted as perforated substantially square boxes, the perforated sections 14 may take on any desired shape such as, for example, perforated substantially circular segments.

In certain embodiments, an embossed, printed or silk screened area 7 is disposed on the front or back side of the tongue section 11 below the perforated sections 14. The embossed, printed or silk screened area 7 may be used to present a customizable logo or other personalized information. For example, a business trade name or other advertising indicia can be printed in the area 7.

Writing and Indicia Surfaces Provided by the Organizer Device

Below the clip 2, the face of the card 1 may contain a writing surface 17 having lines, wherein remarks may be recorded regarding the subject matter. Alternately, the writing surface 17 may be unlined. In certain embodiments, the front or back surface 10 of the card 1 is polypropylene or dry-erase film laminant or made of plastic thereby providing a reusable writing surface for use with washable ink markers or ball-point/roller-ball pens on the front or back surface 10 of the card 1 below the clip 2. This rewritability allows multiple viewers of an article to effectively communicate their notes and comments in a conversational back-and-forth manner, thus enhancing collaboration among team members.

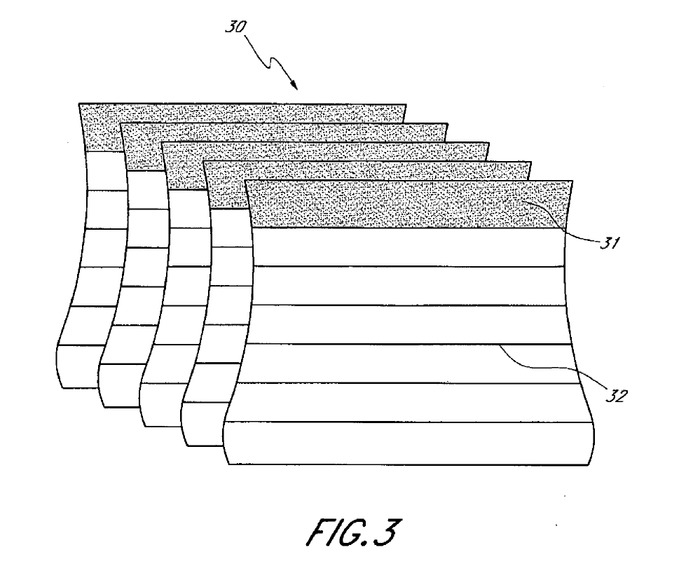

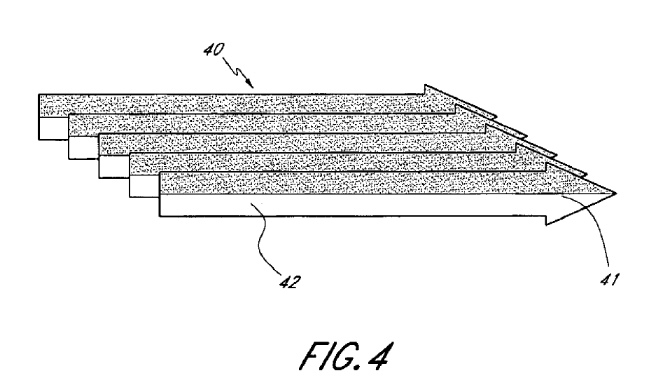

As described in further detail below with respect to FIGS. 3 and 4, in one perforated embodiment, a primary notepad 30 (FIG. 3) of approximately five to fifteen sheets is disposed over the front surface 10 of the clip 1 generally over the writing surface 17. A second notepad (FIG. 4) of approximately one to fifteen sheets is disposed over the front surface 10 of the clip 1 generally the tongue 11 of the clip 2 and above the primary notepad. Advantageously, these notepads provide ample, and replenishable writing surface area for notes, memos, and labels. Also, these notepads enhance project communications, coordination, and collaboration, as team members are able to provide notes and comments regarding sections of a particular article that will be viewed by other members of the team.

When the organizer device is used to retain an article, the topmost portion of the card 1 above the clip 2 extends above the page or pages gripped by the organizer device. This topmost portion may provide visual cues such as color coding to increase the visibility of the organizer device, thus facilitating the use of multiple color-coded organizer devices in certain contexts.

Additionally, in one preferred embodiment, upper and lower portions of the card 1 can be UV coated to increase visibility.

The Back Surface of the Card

FIG. 2 depicts a rear view of the organizer device of FIG. 1. The card 1 comprises a back surface 20. As described in more detail with respect to FIG. 1, the clip 2, formed in the card 1 by a cut shape 13 that defines an upper clip portion 3 and a lower clip portion 4 is visible on the back surface 20 of the card.

Preferably, the entire back surface 20 of the card 1 is made of a hybrid plastic or laminated with a clear lamination 25 of approximately 1.0 mil to 20 mil. The lamination adds strength and durability to the organizer device.

On the back surface 20 of the card 1, the area corresponding with the writing surface 17 of the front surface 10 may contain a blank space 24 for advertising and/or company specific information. The blank space 24 can also be used as a lineless writing area. Alternately, in embodiments where the back surface 20 is plastic or laminated, the blank space 24 may serve as a reusable writing surface for use with washable ink markers or ball-point/roller-ball pens. The blank space 24 of the back surface 20 may also be used to store confidential information. When the organizer device is disposed with the front surface 10 in front of and the tongue section 11 behind the article retained by the clip 2, the writing surface 17 of the front surface 10 is visible. But, the blank space 24 on the back surface 20 faces inward and is obscured by the attached article to keep sensitive information confidential.

The back surface 20 of the card 1 may also contain a lined writing area on a lower portion 6 of the card 1 for use as an indexing card. For example, the fifth lobe 29 may be marked to indicate that the removable lower portion 6 of the card is to be completed with to/from at information and/or other information based on the intended application of the organizer device.

The topmost area of the back surface 20 of the card 1 may be used as a space for marked indicia or color coding similar to the corresponding area on the front surface 10 of the card 1.

The back side of the tongue section 11, likewise, may contain perforated sections 19 (similar to those described above with respect to the front surface 10 in FIG. 1) and a small area where indicia can be marked. In this manner, the organizer device is designed so that it may be disposed forward or backward on a sheet or sheets of paper or other similar materials.

The back surface 20 of the card 1 may also comprise a back flag 26 that is rotatable in the axis of the card about a grommet 28 or other fastener disposed in an aperture 27 cut in the card. The back flag 26 may be used similarly to the front flag 15 to indicate information or decisions. The back flag 26 and the front flag 15 may be color coded to indicate a specific decision to be made. For example, the front flag 15 may be green to indicate a “go” and the back flag 26 may be red to indicate a “no go”. These flags 15, 26 enhance communication and coordination among team members such as where, for example, a second viewer of an article knows not to perform redundant work because a decision has already been reached with respect to the document.

As an added measure of attachment, the organizer device may comprise a bead of pressure sensitive adhesive 23 backing on the back surface 20 of the card 1. The pressure sensitive adhesive 23 bead is preferably disposed just above the perforation 5 allowing separation of the lower portion 6 of the card 1. The pressure sensitive adhesive 23 serves as an anchor in conjunction with the organizer device to keep the card 1 and clip 2 in place on an article. Additionally, the back surface 20 of the card 1 may have a clear peel-off strip disposed over the pressure sensitive adhesive 23 strip until the pressure sensitive adhesive 23 strip is ready for use. Preferably, the pressure sensitive adhesive 23 strip is approximately ¼ inch wide and extends the width of the card 1. Advantageously, this adhesive strip 23 enhances communication by preventing the card 1 from becoming separated from the attached article.

The Primary Notepad of the Organizer Device

FIG. 3 depicts an expanded view of a primary notepad for use in certain embodiments of an organizer device of the present invention. Preferably, the primary notepad 30 comprises approximately one to fifteen sheets of paper removably bound by a bead of pressure sensitive adhesive 31 running along their top back or bottom back edge. FIG. 3 depicts a rear view of several sheets of the primary notepad 30 separated from each other to show their pressure sensitive adhesive 31 beads. Thus, the primary notepad 30 provides self-adhesive or clipping notes which may be removed from the primary notepad 30, and adhered to an article being retained by the organizer device or another surface. Preferably, the size and shape of the primary notepad 30 has the same general dimensions and contours as a portion of the card 1 of the organizer device such that the primary notepad 30 may be disposed over the writing surface 17 of the front surface 10 of the card 1. However, it is recognized that other configurations of the primary notepad may offer the same writing surface and ergonomic functionality. The fifth lobe 29 descends below the lowest extreme of the primary notepad 30, to facilitate pad removal from the clip. Advantageously, if a user exhausts all of the sheets of the primary notepad 30, a replacement primary notepad may be adhered to the card 1 quickly and easily. Therefore, the writing surface provided by the organizer device is virtually limitless, allowing comprehensive note taking and memo writing. In certain embodiments, the primary notepad 30 is lined with a plurality of generally horizontal lines 32 when the card is held upright as well as horizontal lines when the card is held in landscape mode to ease note taking. Advantageously, the primary notepad enhances collaboration and communication by enabling viewers of an article to place written comments within the article at selected areas.

The Secondary Notepad of the Organizer Device

FIG. 4 depicts an expanded view of a secondary notepad for use in an organizer device of the present invention. Preferably, the secondary notepad 40 comprises approximately one to fifteen sheets of paper removably bound by a bead of pressure sensitive adhesive 41 running along their top back edge and/or with glue across the outer top edge whereas each sheet utilizes a clipping mechanism much like that of the Organizer Card. FIG. 4 depicts a rear view of several sheets of the secondary notepad 40 separated from each other to show their pressure sensitive adhesive 41 beads. Thus, the primary notepad 40 provides self-adhesive notes which may be removed from the secondary notepad 40, and adhered to an article being retained by the organizer device or another surface. The secondary notepad 40 is desirably smaller in size than the primary notepad 30 (FIG. 3) such that the sheets of the secondary notepad 40 are used for labeling or highlighting areas of importance rather than comprehensive note taking or memo writing. Preferably, the secondary notepad 40 is sized and configured to be adhered to the front surface 10 of the card 1 just above the clip 2. The secondary notepad 40 may be shaped to facilitate its intended use as a highlighting tool. For example, as depicted in FIG. 4, the secondary notepad 40 may be in a shape to direct a viewer's attention to a selected item when a sheet of the secondary notepad 40 is used. However, other shapes of the secondary notepad 40, including other shapes designed to direct a viewer's attention, are also possible. In certain embodiments, the secondary notepad 40 is lined with at least one generally horizontal line 42 to ease writing thereof. Advantageously, the secondary notepad enhances collaboration and communication by enabling viewers of an article to place small notes within the article at selected areas.

Application of an Organizer Device to an Article

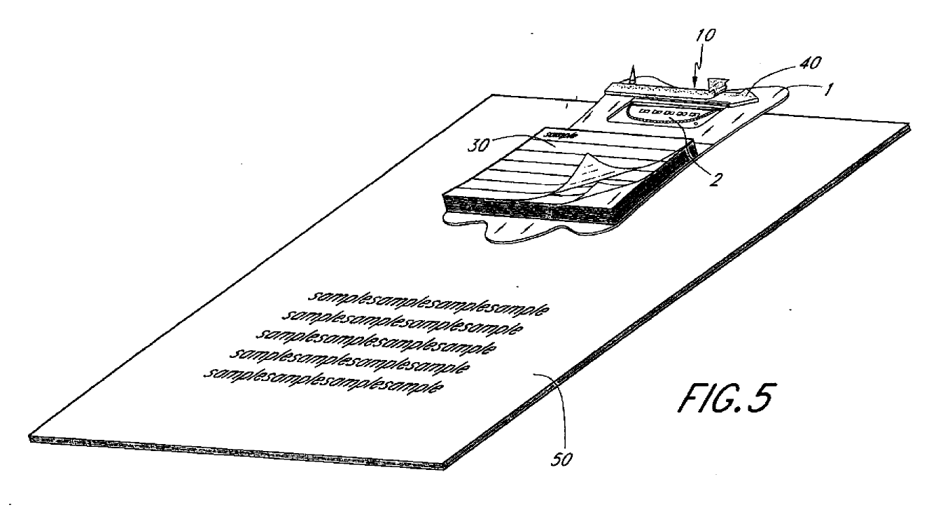

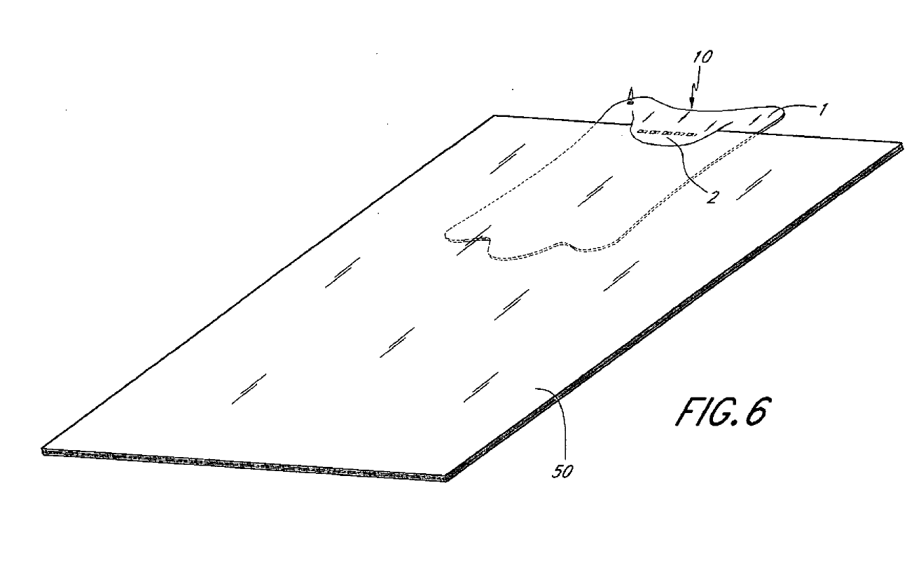

FIGS. 5 and 6 illustrate a preferred embodiment of the organizer device of the present invention as applied to an article 50. As depicted, the card 1 of the organizer is retaining at least one sheet of paper such as a document, folder, report, or manual, comprising an article 50. The organizer device comprises a card 1 having a clip 2 formed on a section of the card 1, a primary notepad 30 disposed on the card, and a secondary notepad 40 disposed on the card. The card 1 and clip 2 are as described above in connection with FIGS. 1 and 2, and the primary and secondary notepads 30, 40 are as described above with respect to FIGS. 3 and 4.

Method of Making an Organizer Device

A method of making an organizer device having a card and a clip formed from the card is also within the scope of the present invention. Generally, the method comprises the steps of providing paper or plastic for at least one card, cutting the card with a laser or steel rule die to form a clip having a tongue and a cut window, and cutting the card from the material being used. Additional steps may be implemented in the method, such as providing ink or silkscreen printing a predetermined pattern on at least one side of the card. Alternatively additional steps may be to enhance the gripping ability of the card, such as applying an adhesive strip to a surface of at least one side of a card or adhering a gripping surface to the tongue of the clip. Alternately, additional steps may be added that enhance writing and information providing surfaces of the card such as embossing predetermined text on the card, laminating at least one surface of the card, and attaching at least one flag or category wheel to the card.

The card of the organizer device, along with the clip and perforations is achieved through laser or steel rule die cutting or other similar techniques in order to produce clean, sharp and durable edges. In another embodiment, the organizer device may be made with an overall card tear-out perforation cut, allowing the organizer device to be vended in sheets that may be fed through a home or office printer; thus, allowing the ability to personalize the contents or theme of the organizer device, or to produce organizer devices in a series where necessary.

Method of Using an Organizer Device

A method of using an organizer device having a card and a clip formed from the card is also within the scope of the present invention. The method of using an organizer device comprises the steps of inserting an article into the clip and marking status information about the article on the organizer device. The marking step may be accomplished by any of a number of ways, as enabled by the features of the organizer device. For example, the marking may be a mark in a perforated section on the tongue of the clip, a punch-out of the perforated section, a written comment on a surface of the card, a written comment on a notepad, or a rotating a flag or category wheel. The method of using an organizer device may also include removing a portion of the card along a perforation in the card and storing it in a card file.

A method of using an organizer clip according to an embodiment of the invention includes color-coding the flag or wheel for a designated purpose to facilitate organization and coordination. Where the organizer device is used in the real estate industry, for example, the flag or wheel can be used to coordinate customer service by marking the status of activities required to complete a purchase of a home. The flag or wheel is color-coded to indicate the status information, such as green representing “attention required”, yellow representing “ready to be processed”, and red representing “please correct before processing”. The flag or wheel is moved or rotated to a signifying position where a designated color marks the status of the matter, indicating its importance, its percentage of completion, or the time for its completion. Advantageously, as further described above with respect to components of various embodiments of organizer device, the method of using the organizer device enhances communication, collaboration, and coordination among members of a team.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Further, the various features of this invention can be used alone, or in combination with other features of this invention other than as expressly described above. Thus, it is intended that the scope of the present invention herein disclosed should not be limited by the particular disclosed embodiments described above, but should be determined only by a fair reading of the claims that follow.

I claim:

1. An organizer device having enhanced organizational functionality comprising:
a card having an ergonomic shape;
a clip integrally formed on said card and configured to retain at least one planar element, said clip formed by a tongue disposed in a cut shape opening; and
at least one indicator movably mounted to a surface of said card, wherein said indicator is coded for a designated purpose to facilitate organization and coordination.

2. A plurality of organizer devices according to claim 1 attached by a fastener.

3. An organizer device according to claim 1, wherein:
said card has an ergonomic shape defined by at least one concave edge;
said card has an upper portion and a lower portion;
said clip is integrally formed on said upper portion of said card;
a plurality of paper sheets removably affixed below said clip on said lower portion of said card.

4. An organizer device according to claim 2, wherein said upper portion is separated from said lower portion by a perforation, such that said lower portion is separable from said upper portion at said perforation.

5. An organizer device according to claim 2, wherein said lower portion of said card further comprises at least one perforated punch-out that is separably attached to said lower portion, said perforated punch-out capable of being used as a card for indexing.

6. An organizer device according to claim 1, wherein said indicator is a movable flag.

7. An organizer device according to claim 6, wherein said flag is rotatably mounted to said upper portion of said card, said upper portion defined by a top edge, such that said flag can be rotated from a first position below said top edge to a second position above said top edge.

8. An organizer device according to claim 6, wherein said flag contains at least one color, said color coded for said designated purpose.

9. An organizer device according to claim 6, wherein said flag contains a plurality of colors, each said color coded for said designated purpose.

10. An organizer device according to claim 6, wherein said flag contains printed indicia, said printed indicia coded for said designated purpose.

11. An organizer device according to claim 1, wherein said indicator is a rotatable wheel.

12. An organizer device according to claim 11, wherein said rotatable wheel contains at least one color, said color coded for said designated purpose.

13. An organizer device according to claim 11, wherein said rotatable wheel contains a plurality of colors, each said color coded for said designated purpose.

14. An organizer device according to claim 11, wherein said rotatable wheel contains printed indicia, said printed indicia coded for said designated purpose.

15. An organizer device according to claim 14 having a window formed by a cut out in said card to review said printed indicia on said rotatable wheel.

16. An organizer device according to claim 1, wherein said clip is configured to retain a card of predetermined size via a tension fit between the walls of the clip.

17. An organizer device according to claim 1, wherein said card further comprises a writing surface disposed on at least one surface of said card.

18. An organizer device according to claim 1, wherein said tongue further comprises at lease one removable perforated section.

19. An organizer device according to claim 1, said card having a slot in said upper portion for attaching an accessory.

20. An organizer device according to claim 1 having a fifth lobe, said fifth lobe capable of functioning as an anchor element for mating with a receiving unit.

21. An organizer device according to claim 1 having a lanyard.

22. An organizer device according to claim 1 having a notepad removably adhered to a surface of said card.

23. An organizer device according to claim 1 having an advertising label removably adhered to a surface of said card.

24. An organizer device according to claim 1, said indicator comprises a plurality of flags movably mounted to a surface of said card, said plurality of flags centrally connected to rotate about a common axis, wherein each of said plurality of flags are coded for said designated purpose to facilitate organization and coordination.

25. An organizer device according to claim 24, wherein said plurality of flags contain a plurality of colors, each said color coded for said designated purpose.

26. An organizer device according to claim 24, wherein said flags are located substantially at the center of said tongue.

27. An organizer device according to claim 24, wherein:
a first flag is rotatably mounted to a front surface of said card; and
a second flag is rotatably mounted to a second surface of said card.

28. An organizer device having enhanced organizational functionality comprising:
a card having an ergonomic shape, a writing surface disposed on at least one surface of said card, and a slot for attaching an accessory;
said card having an upper portion and a lower portion, said upper portion being separable from said lower portion by a perforation;
a slot formed in said upper portion for attaching an accessory a clip integrally formed on said upper portion of said card and configured to retain at least one planar element, said clip formed by a tongue disposed in a cut shape opening; said clip is configured to retain a card of predetermined size;
a plurality of paper sheets removably affixed below said clip on said lower portion of said card; and
at least one indicator movably mounted to a surface of said card, wherein said indicator is coded for a designated purpose to facilitate organization and coordination.

29. A method for enhancing coordination, communication, and collaboration by use of an organizer device, including the steps of:
attaching said organizer device to a planar element by means of a clip, said clip being integrally formed on said card and configured to retain said planar element with a tongue disposed in a cut shape opening; and
indicating the status of said planar element by means of a movable indicator, said movable indicator mounted to a surface of said card, wherein said indicator is coded for a designated purpose to facilitate organization and coordination.
